(19) United States
(12) Patent Application Publication
(10) Pub. No.: US 2013/0176092 A1
(43) Pub. Date: Jul. 11, 2013

(54) COOLED TRANSFORMER HAVING AT LEAST ONE STRIP WINDING

(71) Applicant: ABB Technology AG, Zurich (CH)

(72) Inventors: Benjamin Weber WEBER, Winterberg (DE); Bhavesh Patel, Brilon (DE); Burak Esenlik, Paderborn (DE); Frank Cornelius, Olsberg (DE); Marcos Bockholt, Paderborn (DE); Jens Tepper, Brilon (DE)

(73) Assignee: ABB Technology AG, Zurich (CH)

(21) Appl. No.: 13/780,519

(22) Filed: Feb. 28, 2013

Related U.S. Application Data
(63) Continuation of application No. PCT/EP2011/003569, filed on Jul. 18, 2011.

(30) Foreign Application Priority Data
Sep. 1, 2010 (EP) 1009063.8

(51) Int. Cl. H01F 27/08; H01F 30/12

(52) U.S. Cl. CPC H01F 27/08; H01F 30/12
USPC 336/5; 336/60

(57) ABSTRACT

A strip winding for a transformer includes a plurality of winding modules each having a strip conductor wound around a winding axis. A winding segment is formed by at least two radially adjacent winding modules. At least one cooling channel extending in the axial direction is provided between at least two radially adjacent winding modules. At least two axially adjacent winding segments are provided, and the winding modules are connected electrically in series by connecting conductors. At least one connecting conductor is led at least in sections through the cooling channel along the axial extension of the cooling channel.

### RELATED APPLICATIONS

This application claims priority as a continuation application under 35 U.S.C. §120 to PCT/EP2011/0033569, which was filed as an International Application on Jul. 18, 2011 designating the U.S., and which claims priority to European Application 1009063.8 filed in Europe on Sep. 10, 2010. The entire contents of these applications are hereby incorporated by reference in their entireties.

### FIELD

The present disclosure relates to a strip winding for a transformer, and to a cooled transformer having the strip winding.

### BACKGROUND INFORMATION

Strip windings are often used on the low-voltage side as windings for dry-type transformers, for example, in the power range of a few 100 kW up to 10 MW and above. Strip windings have the advantage of conducting correspondingly high currents given a relatively low voltage on the secondary side of a few kV, wherein here, the skin effect is advantageously reduced by the flat conductor construction, for example. On the high-voltage side, given a primary voltage of a few 10 kV, for example, the conductor current is correspondingly lower, with the result that, in this case, a winding having a round or rectangular conductor has proven to be expedient. The low-voltage winding and high-voltage winding are usually manufactured on the same coil former, wherein, for reasons of insulation, the low-voltage winding is arranged radially on the inside and the high-voltage winding is arranged radially on the outside.

Winding conductors for strip windings may have a rectangular cross section, wherein the winding is constructed in the form of a roll per se. A winding layer accordingly has precisely one rectangular winding conductor which is insulated on the outside and which is wound helically around a winding axis. Depending on the transformer design, however, it may be expedient to arrange two or more such windings axially one above the other on a core limb of a transformer.

Furthermore, for cooling purposes, usually there may be one cooling channel guided along the axial extent of the winding for passing the lost heat out of the winding interior, for example, by means of natural air cooling. In order to achieve an optimum cooling effect, a strip winding is split in the radial direction into a plurality of hollow-cylindrical sections or modules, wherein a usually likewise hollow-cylindrical cooling channel is formed between two radially adjoining modules. For its part, the cooling channel is formed from a plurality of tubular, relatively small channels as well, depending on the embodiment.

Therefore, it is known for strip windings to be formed from adjoining winding modules both in the axial and in the radial direction, where the winding modules are connected in series so as to achieve the desired electrical functionality. In this case, care should be taken to ensure the correct winding sense of the winding modules, with the result that a voltage induced in the individual modules is not mutually compensated for, even partially.

However, one drawback is that, when manufacturing such strip conductor windings, an electrical series circuit of the individual modules can usually only be provided once the outermost winding module has been wound. In the case of a high-voltage winding which is generally to be provided radially, this results in elaborate and space-consuming conductor routing about the radially outer high-voltage winding.

### SUMMARY

An exemplary embodiment of the present disclosure provides a strip winding for a transformer. The exemplary strip winding includes a plurality of winding modules each having a strip conductor which is wound around a winding axis. The exemplary strip winding also includes at least two axially adjacent winding segments, where each winding segment is formed by at least two radially adjacent winding modules among the plurality of winding modules. In addition, the exemplary strip winding includes at least one cooling channel running in the axial direction between at least two of the radially adjacent winding modules, and connecting conductors configured to connect the winding modules electrically in series. At least one of the connecting conductors is guided at least sectionally along an axial extent of the cooling channel through the cooling channel.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a section through a strip winding according to an exemplary embodiment of the present disclosure;

FIG. 2 shows a plan view of a strip winding according to an exemplary embodiment of the present disclosure;

FIG. 3 shows a section through a strip winding according to an exemplary embodiment of the present disclosure;

FIG. 4 shows a section through a strip winding according to an exemplary embodiment of the present disclosure;

FIG. 5 shows a section through a strip winding according to an exemplary embodiment of the present disclosure; and

FIG. 6 shows a side view of a three-phase transformer with a strip winding according to an exemplary embodiment of the present disclosure.

### DETAILED DESCRIPTION

Exemplary embodiments of the present disclosure provide a space-saving and simplified construction for an electrical series circuit of the individual winding modules of a strip winding.

An exemplary embodiment of the present disclosure provides a strip winding for a transformer. The exemplary strip winding includes a plurality of winding modules each having a strip conductor which is wound around a winding axis. The exemplary strip winding also includes at least two axially adjacent winding segments, where each winding segment is formed by at least two radially adjacent winding modules among the plurality of winding modules. In addition, the exemplary strip winding includes at least one cooling channel running in the axial direction between at least two of the radially adjacent winding modules, and connecting conductors configured to connect the winding modules electrically in series. At least one of the connecting conductors is guided at least sectionally along an axial extent of the cooling channel through the cooling channel.

Exemplary embodiments of the present disclosure are based on the idea of using the space provided in the interior of the cooling channel for the arrangement of connecting conductors of the strip winding. Connecting conductors are usually in the form of rods, with the result that the cooling effect is only insubstantially impaired thereby, if at all. The connecting conductors can be introduced into the cooling channels of the winding when the cooling channels are produced. Coil manufacture would then generally only include the winding of the radially innermost modules, followed by the introduction of the cooling channel, wherein, at least one of the winding ends of the radially innermost winding modules can be guided through at least one section of the cooling channel by means of the connecting conductors to one of the end sides of the winding to be manufactured. Once the cooling channel has been introduced, the radially following winding modules then need to be wound, and, if appropriate, a conductor end can be guided by means of a connecting conductor provided in the cooling channel to one of the two end sides.

This advantageously makes it possible, even once winding of a radially outer high-voltage winding is complete, to connect the connecting conductors passed out at the end sides to one another in a space-saving manner. Depending on the number of axially and radially adjoining winding modules, a large number of possible connection variants results. As mentioned at the outset, in any case attention should be paid to the winding sense of the respective winding modules, as a result of which there is an additional boundary condition for the arrangement of the connecting conductors.

In accordance with an exemplary embodiment of the strip winding according to the present disclosure, an extended end-lead rail is provided as connecting conductor, which is guided through the cooling channel. End-lead rails have good connection possibilities to further end-lead rails, at least at one of their ends, at the end side for connecting the individual winding modules. In addition, end-lead rails are commercially available component parts which do not require any additional complexity in terms of construction and which in terms of their diameter, for example of a few centimeters, need to be accommodated easily in a cooling channel.

In accordance with an exemplary embodiment of the present disclosure, at least two connecting conductors are electrically connected on an end face or an end side of the strip winding. Subsequently, connecting the winding segments is facilitated once the winding of all required winding segments including a possible high-voltage winding is complete for accessibility reasons on one of the end sides of the winding.

The advantageous effects achieved by a strip winding according to the present disclosure also apply correspondingly to a transformer including a transformer core, at least one strip winding according to the present disclosure as a low-voltage winding, and at least one further DC-isolated winding as high-voltage winding. In accordance with an exemplary embodiment, both a design of the entire transformer which is reduced in size and a simplified assembly are thereby enabled. In order to be able to be used in power distribution systems, such a transformer can have a three-phase design, for example, has in total three high-voltage windings and three low-voltage windings, which are DC isolated from one another.

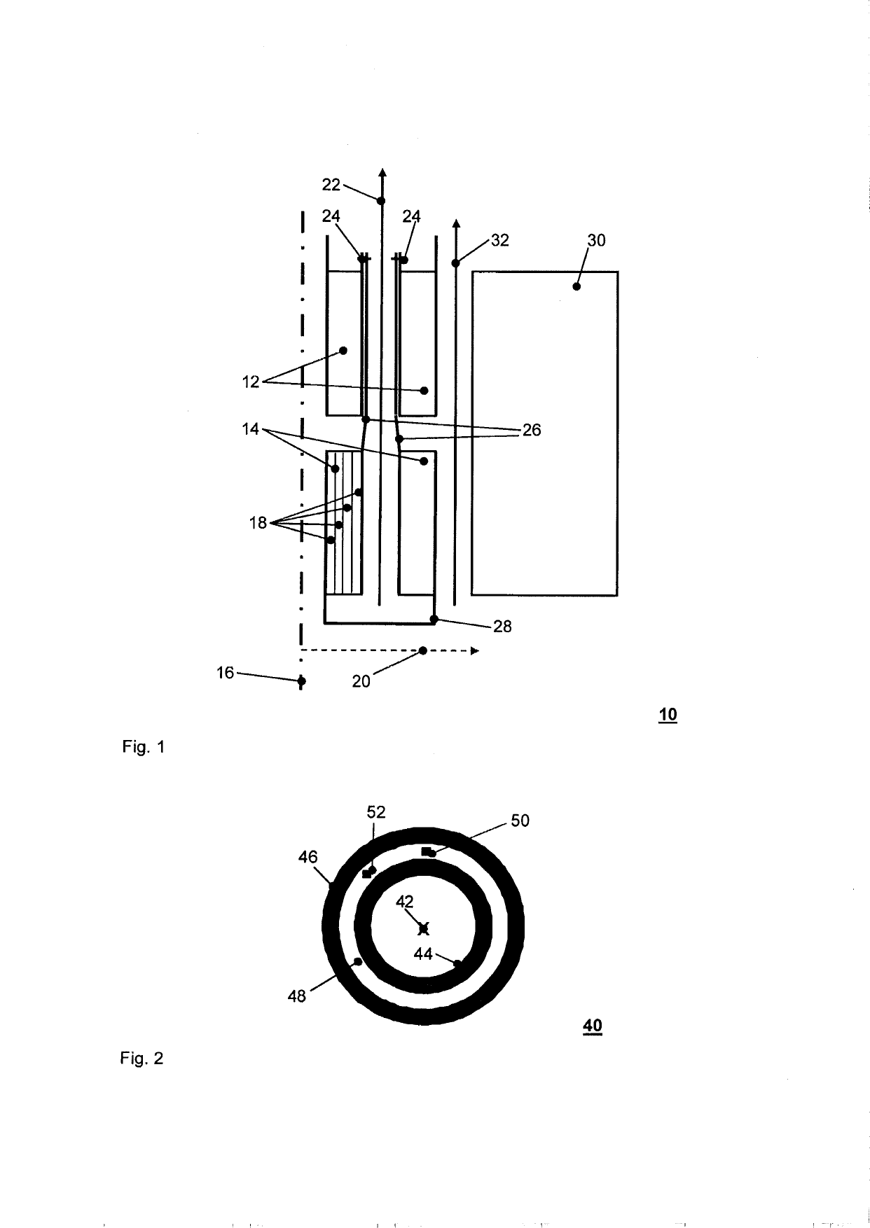

FIG. 1 shows a section 10 through an exemplary embodiment of a strip winding, which extends approximately rotationally symmetrically about a winding axis 16. The strip winding has two winding segments, wherein the first winding segment is formed by two radially adjacent winding modules (e.g., segments) 12, and the second winding segment is formed by two winding modules (e.g., segments) 14 which are radially adjacent along the axis indicated by the reference numeral 20. The winding segments 12, 14 are illustrated in each case as a rectangle in terms of their cross section, wherein the winding segment 14 illustrated at the bottom left in FIG. 1 is also illustrated in a plurality of winding layers 18 of a strip conductor. Each winding layer is surrounded by an insulating layer in order to be able to insulate a voltage difference at least with respect to the adjacent winding layer. Depending on the embodiment of the winding, the insulation may also needs be designed for the rated voltage. Such a strip conductor has a width of several centimeters up to just under two meters, for example, depending on the embodiment, wherein the number of winding layers markedly exceeds the four layers illustrated here, for example several tens of layers. Owing to the arrangement around the common axis 16, each winding segment 12, 14 has an approximately hollow-cylindrical configuration.

A cooling channel which extends over the entire axial length of the winding, which can be produced, for example, predominantly from an insulating plastics material, for example, and is indicated by the reference arrow 22, is arranged between the radially adjoining winding modules. Such a cooling channel can be manufactured from shell segments, for example, which, in assembled form, result in two hollow cylinders nested one inside the other, wherein the actual cooling channel is formed by the interior surrounded by the hollow cylinders. For reasons of structural stability, the hollow cylinders are spaced apart from one another by suitable elements, which may be aligned in the axial direction, for example by webs. Two of the electrical connections of the winding modules 14 of the second winding segment are guided via connecting conductors 26 in a space-saving manner in the interior of the cooling channel 22 to the upper end side of the strip winding. There, they are electrically connected to connections of the winding modules 12 of the first winding segment at connecting points 24, for example, by means of a screw connection. The respective other electrical connections of the two winding modules 14 are connected to one another at the opposite end side using a connecting conductor 28, with the result that all four winding modules are connected electrically in series.

A high-voltage winding 30 is provided radially on the outside and is arranged spaced apart by a stray channel 32 around the radially outer winding module. The stray channel 32 is likewise suitable, if necessary, for guiding connecting conductors 26 at least sectionally in the stray channel 32 to one of the two end sides of the winding.

FIG. 2 shows a plan view 40 of an exemplary embodiment of a strip winding according to the present disclosure. In this view, once again the hollow-cylindrical form of winding modules 44, 46 arranged around an axis of rotation 42 is apparent, with a likewise hollow-cylindrical cooling channel 48 being indicated between the winding modules 44, 46. Within this cooling channel, two rod-like connecting conductors with a square cross section are indicated by the reference numerals 50, 52. An electrical connection of axially adjoining winding modules is possible with the connecting conductors 50, 52.

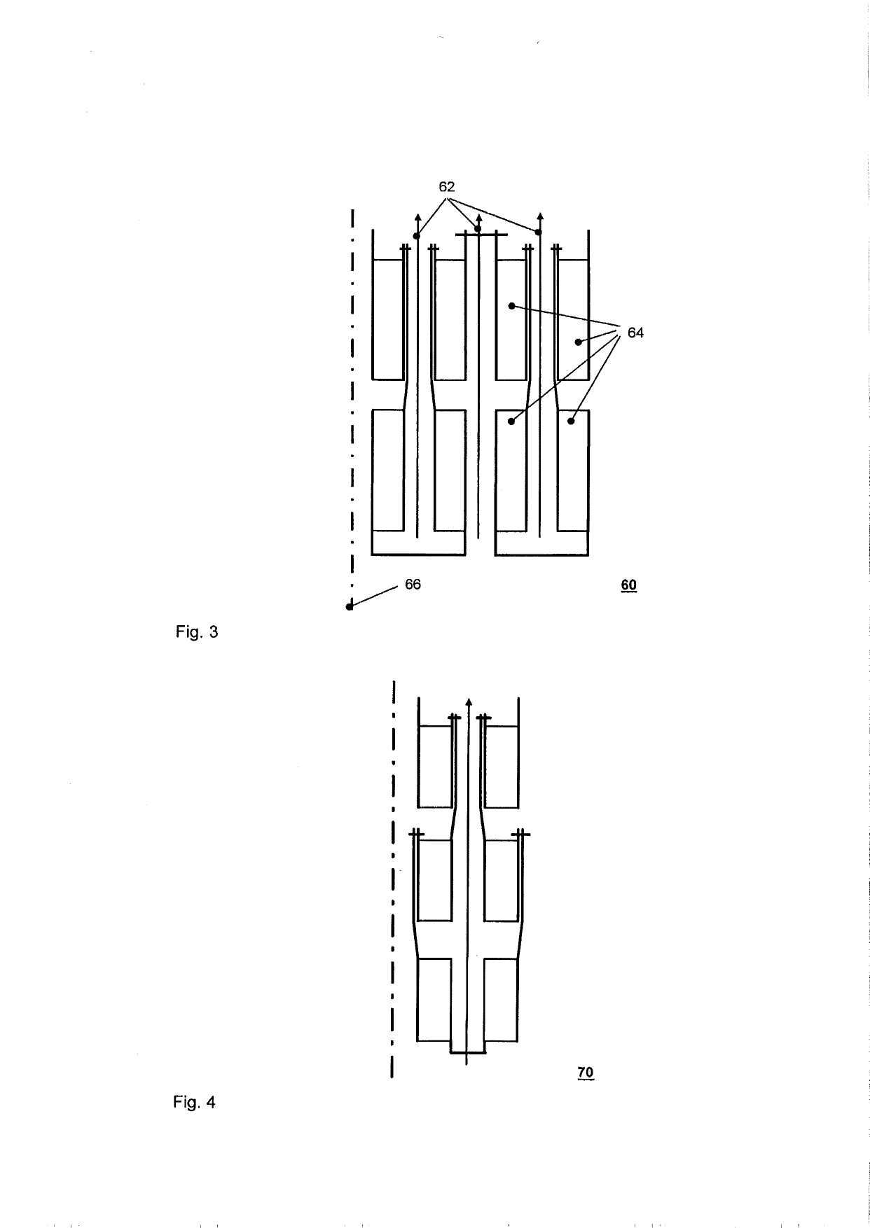

FIG. 3 shows a section 60 through an exemplary embodiment of a strip winding according to the present disclosure. This strip winding has a very similar design to the winding shown in FIG. 1, but in total eight winding modules 64 in two winding segments are provided, wherein in total three cooling channels 62 are formed. However, in this example, connecting conductors are only guided in the radially inner and radially outer cooling channel. A high-voltage winding is not shown, but can be considered as being provided radially on the outside.

FIG. 4 shows a section 70 through an exemplary embodiment of a strip winding, in which in total six winding modules in three winding segments are provided. The electrical connection of the axially central winding segment is performed at connecting points which sometimes do not rest on one of the end faces. This requires additional care when performing the winding operation of the respective winding modules, which is thus slightly more complex.

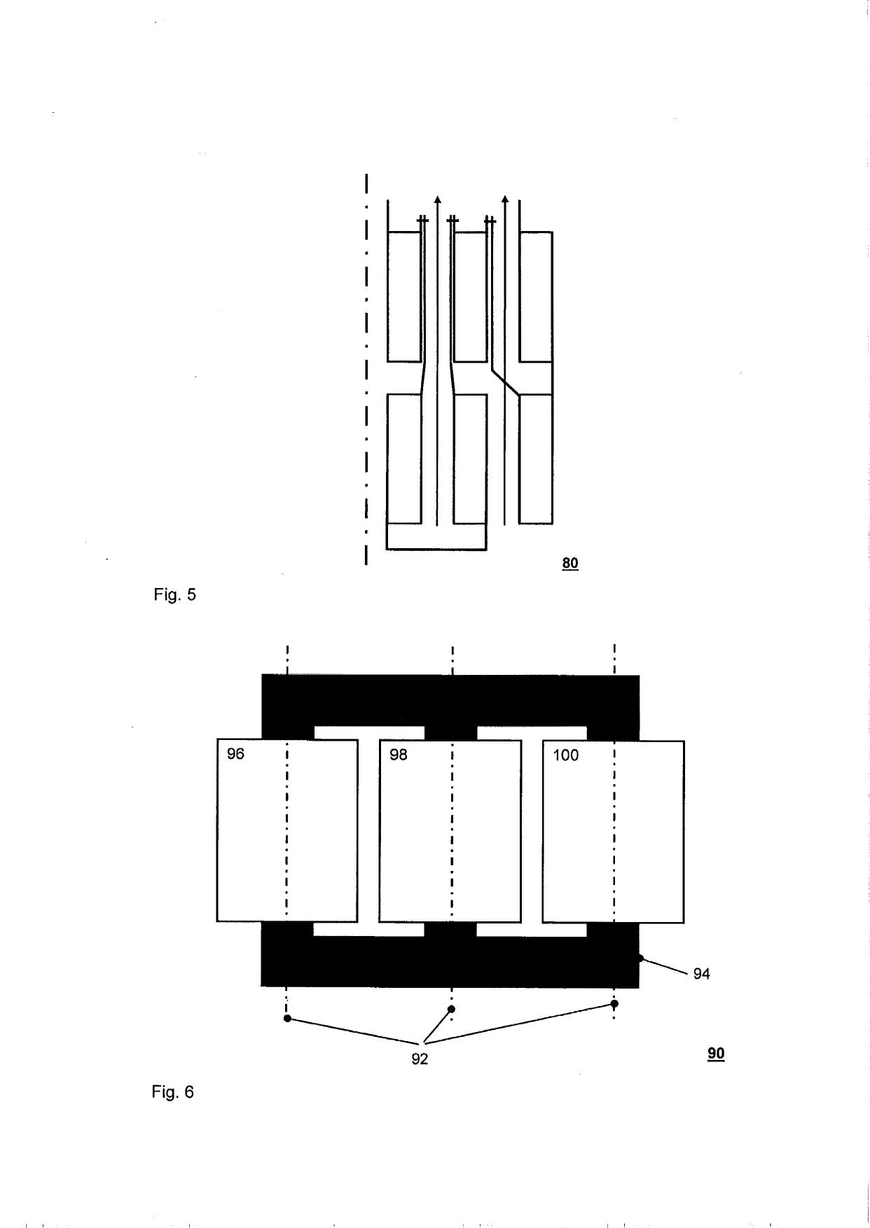

FIG. 5 shows an exemplary embodiment of a strip winding according to the present disclosure in the form of a section 80 through the exemplary strip winding, this time with six winding modules, two winding segments and two cooling channels. When interconnecting the respective winding modules, it can clearly be seen that the respective winding sense of the winding modules is to be considered, with the result that the voltages induced in the winding modules do not cancel one another out.

FIG. 6 shows a side view 90 of a three-phase transformer with a strip winding according to an exemplary embodiment of the present disclosure. In total, three common coil formers 96, 98, 100 are provided, which each have, radially on the inside, a low-voltage-side strip winding and, radially on the outside, a high-voltage-side round or rectangular material winding, which is not apparent from this illustration, however. Each of the three coil formers is arranged along a respective winding axis 92 around a respective limb of a three-phase transformer core 94. By virtue of the arrangement according to the disclosure of connecting conductors in cooling channels, the physical size of the transformer is reduced or, given the same physical size, an increased rated power is achieved.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Section through a first exemplary strip winding
12 Winding modules of a first winding segment
14 Winding modules of a second winding segment
16 Winding axis
18 Winding layers of a strip conductor
20 Radial extent of strip winding
22 Cooling channel
24 Connecting point at first end side
26 Connecting conductor
28 Connecting conductor at second end side
30 High-voltage winding
32 Stray channel
40 Plan view of second exemplary strip winding
42 Winding axis
44 First winding module
46 Second winding module
48 Cooling channel
50 First connecting conductor guided in cooling channel
52 Second connecting conductor guided in cooling channel
60 Section through a third exemplary strip winding
62 Cooling channels
64 Winding modules
66 Winding axis
70 Section through a fourth exemplary strip winding
80 Section through a fifth exemplary strip winding
90 Side view of three-phase transformer with strip winding
92 Winding axes
94 Transformer core
96 First low-voltage winding with first high-voltage winding
98 Second low-voltage winding with second high-voltage winding
100 Third low-voltage winding with third high-voltage winding

What is claimed is:

1. A strip winding for a transformer, comprising:
a plurality of winding modules each having a strip conductor which is wound around a winding axis;
at least two axially adjacent winding segments, each winding segment being formed by at least two radially adjacent winding modules among the plurality of winding modules;
at least one cooling channel running in the axial direction between at least two of the radially adjacent winding modules; and
connecting conductors configured to connect the winding modules electrically in series,
wherein at least one of the connecting conductors is guided at least sectionally along an axial extent of the cooling channel through the cooling channel.

2. The strip winding as claimed in claim 1, wherein at least one of the connecting conductors includes an end-lead rail which is guided through the cooling channel.

3. The strip winding as claimed in claim 1, wherein at least two of the connecting conductors are electrically connected on an end face of the strip winding.

4. A transformer comprising:
a transformer core;
at least one strip winding as claimed in claim 1 as a low-voltage winding; and
at least one further DC-isolated winding as a high-voltage winding.

5. The transformer as claimed in claim 4, wherein the transformer has a three-phase configuration.

6. The strip winding as claimed in claim 2, wherein at least two of the connecting conductors are electrically connected on an end face of the strip winding.

7. A transformer comprising:
a transformer core;
at least one strip winding as claimed in claim 2 as a low-voltage winding; and
at least one further DC-isolated winding as a high-voltage winding.

8. The transformer as claimed in claim 7, wherein the transformer has a three-phase configuration.

9. A transformer comprising:
a transformer core;
at least one strip winding as claimed in claim 3 as a low-voltage winding; and
at least one further DC-isolated winding as a high-voltage winding.

10. The transformer as claimed in claim 9, wherein the transformer has a three-phase configuration.
